(19) United States
(12) Patent Application Publication
(10) Pub. No.: US 2009/0307924 A1
(43) Pub. Date: Dec. 17, 2009

(54) Fabric conditioning composition dispensing device

(76) Inventors: Yousef Georges Aouad, Cincinnati, OH (US); Scott Edward Smith, Cincinnati, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/157,994

(22) Filed: Jun. 16, 2008

(51) Int. Cl. F26B 7/00; B65D 8/00; B65D 69/00; B65D 83/00

(52) U.S. Cl. 34/389; 220/669; 206/229; 222/394

(57) ABSTRACT

A composition dispensing container being formed of a hollow body forming an inner volume, said hollow body comprising: a single layer interface between said inner volume and the environment exterior to said hollow body; a composition ingress portal allowing a composition to be introduced into said inner volume from the environment exterior to said hollow body; and at least one composition egress portal allowing a composition to exit said inner volume to the environment exterior to said hollow body through said single layer interface; and a one-way entry valve operably connected to said composition ingress portal.

### FIELD OF THE INVENTION

The present invention relates to the field of dispensing devices for fabric conditioning compositions during the automatic washing and/or automatic drying processes.

### BACKGROUND OF THE INVENTION

There exists a continuing need to deliver certain desired benefits to fabrics during the laundering process. Fabric conditioning compositions are typically available as either liquid or solid compositions.

Liquid fabric conditioning compositions are typically used during the wash and/or rinse process. One approach for dispensing liquid fabric conditioning compositions during the wash and/or rinse process includes the use of hollow body devices for liquid fabric conditioning compositions. One problem with the use of liquid fabric conditioning compositions during the washing process is that a large portion of the fabric conditioning composition is discharged from the washing machine with the waste water. Problems related to liquid fabric conditioning compositions include spillage when loading the measuring devices. Thus, there remains a need for devices and methods to dispense liquid fabric conditioning compositions in a more efficient and less unsightly manner.

Solid fabric conditioning compositions include dryer sheets and are typically used during the drying process using automatic drying machines. One problem with the use of solid fabric conditioning compositions during the drying process is that the solid fabric conditioning compositions are generally more expensive as compared to the liquid fabric conditioning compositions on a per use basis. As such there remains a need for devices and methods to dispense fabric conditioning compositions in any form, on a less expensive per use basis.

Attempts to deliver liquid fabric conditioners to fabrics during the drying process include: devices comprising dispensing openings which require that the liquid fabric conditioner to be dosed into a chamber which is kept apart from any dispensing openings. Indeed, these attempts have focused on isolating any liquid fabric conditioner from any dispensing openings during charging and prior to introduction into the basin of the bumble dryer. One known attempt requires the additional element of a separate measuring cup to hold product away from hollow sphere and thereby prevent premature release of product prior to introduction into the dryer. Another attempt requires the specific placement of dispensing openings into the container caps and away from the hollow sphere. Problems encountered with the introduction of a separate measuring cup include: manufacturing complexity required to introduce an additional measuring cup into the interior of the device, and insufficient user friendliness as these attempts still require the user to handle the device in a position where any liquid fabric conditioner composition does not come into contact with the dispensing openings. Thus, there remains a need for easy to manufacture, user-friendly, devices which are less susceptible to spillage and leaking.

A number of devices for dispensing liquid fabric conditioning compositions have been disclosed. See e.g. U.S. Pat. Nos. 3,706,140; 4,014,105; 5,040,311; 6,574,883; and 5,966,831, and U.S. Patent Application Publication No. 2007/0000142.

### SUMMARY OF THE INVENTION

One aspect of the present invention provides for a composition dispensing container comprising: a hollow body forming an inner volume, said hollow body comprising: a single layer interface between said inner volume and the environment exterior to said hollow body; a composition ingress portal allowing a composition to be introduced into said inner volume from the environment exterior to said hollow body; and at least one composition egress portal allowing a composition to exit said inner volume to the environment exterior to said hollow body; and a one-way entry valve operably connected to said composition ingress portal.

Another aspect of the present invention provides for a kit comprising: a composition storage container comprising: a reservoir; and a composition dispensing container according to the present invention, wherein said composition storage container and said composition dispensing container are releasably attached, forming a fluid transportation channel.

Yet another aspect of the invention provides a process for treating a fabric in a dryer cycle comprising: charging a composition dispensing container according to the present invention with a fabric conditioning composition; introducing said charged composition dispensing container into an automatic dryer; providing a fabric into said automatic dryer either before or after step (b); and running said automatic dryer containing said charged composition dispensing container and said fabric.

### BRIEF DESCRIPTION OF THE DRAWINGS

FIG. 1 provides a frontal view of one embodiment of the present invention.

FIG. 2 provides a top view of another embodiment of the present invention.

FIG. 3 provides a cross sectional view of the embodiment of the present invention shown in FIG. 2.

FIG. 4 provides a frontal view of the hollow body in accordance with one embodiment of the present invention.

FIG. 5 provides a frontal view of a cap in accordance with the present invention.

FIG. 6 provides a frontal view of an embodiment of the present invention wherein the hollow body of FIG. 4 is removably attached to the cap of FIG. 5.

FIG. 7 provides yet another embodiment of the present invention comprising a frontal view of a composition dispensing container and a composition storage container.

FIG. 8 provides yet another embodiment of the present invention comprising a cross sectional view of a composition dispensing container and a frontal view of a composition storage container.

FIG. 9 provides a frontal view of a composition dispensing container in accordance with the present invention.

FIG. 10 also provides a frontal view of another composition dispensing container in accordance with the present invention.

FIG. 11 provides a partly exploded frontal view of a composition dispensing container and an egress portal seal in accordance with the present invention.

FIG. 12 provides a cross sectional view of another embodiment of the present invention.

### DETAILED DESCRIPTION OF THE INVENTION

It has importantly been found that the present invention provides an easy to use and easy to manufacture device for treatment of fabrics during the drying process as well as the washing and/or rinse process, due in part to the effect of the combined elements recited and disclosed herein. Further, it has importantly been found that the present invention is user friendly and can be charged or loaded with a liquid or fluidized fabric conditioner in a single step, thereby being less likely to result in product leakage during use or handling prior to being introduced into the drum of an automatic dryer machine. Although the composition dispensing container is suitable for use in the automatic dryer, it can also advantageously be used in the washing process.

### 1. Composition Dispensing Container

The composition dispensing container of the present invention is suitable for dispensing of fabric conditioning compositions in automatic dryers and/or automatic washing machines. The composition dispensing container comprises: a hollow body forming an inner volume, said hollow body comprising: a single layer interface between said inner volume and the environment exterior to said hollow body; a composition ingress portal allowing a composition to be introduced into said inner volume from the environment exterior to said hollow body; and at least one composition egress portal allowing a composition to exit said inner volume to the environment exterior to said hollow body; and a one-way entry valve operably connected to said composition ingress portal.

a. Hollow Body

The hollow body forms single layer interface defining an inner volume adapted to accommodate a measured amount of a fabric conditioner composition. In one embodiment of the present invention, the hollow body comprises a plastic material. Examples of suitable plastic materials include but are not limited to: polyurethane, polyethylene, polypropylene, polypropleyene co-polymer and mixtures thereof. Non-limiting examples of devices comprising suitable plastic materials for use herein are provided in U.S. Pat. No. 6,674,883 and U.S. Patent Application Publication No. 2007/0000142, both of which are incorporated herein. In one embodiment, the plastic material has a melting point of no less than 180° F., alternatively no less than 200° F.

In one embodiment the plastic material of the hollow body is translucent to facilitate viewing of any contents located within said hollow body. In another embodiment, the plastic material of the hollow body is opaque. In yet another embodiment, the hollow body comprises a mixture or combination of plastic materials wherein discrete portions of the hollow body can be translucent and/or opaque.

Suitable shapes for the hollow body include but are not limited to spherical or ball shapes, such as the Downy Ball® as sold by The Procter & Gamble Company. Without intending to be bound by theory, it is believed that a spherical or ball shape allows the device to come into contact with the fabrics during the wash or drying cycle while being less susceptible to becoming entangled when compared to other shapes such as squares or triangles.

b. Single Layer Interface

The single layer interface between said inner volume and the environment exterior to said hollow body is such that that there is only a single layer or wall separating any fabric conditioner composition located in the inner volume from the external environment. As such, when a fabric conditioner exits the inner volume, it need only travel through a single layer interface until it is released to the exterior environment where it can come into contact with the exterior of the hollow body, the drum of the tumble dryer and/or any fabrics to be treated.

In one embodiment, the single layer interface has a thickness of from about 0.05 cm to about 2 cm, or about 0.1 cm to about 1 cm, or about 0.5 cm to about 0.75 cm. The hollow body of the present invention does not require a separate measuring cup. It is preferred for any measuring function to be performed directly within the hollow body. In one embodiment, the composition dispensing container comprises an indicia for measuring or dosing the fabric conditioner composition, as disclosed herein as a fill line.

In one embodiment, the hollow body consists essentially of a single compartment which performs the multi-functions of receiving a liquid composition, allowing the user to measure the amount of composition being transferred, and dispensing said composition. It is believed that a single compartment allows for simplified manufacturing which can be less expensive and time consuming. Further, it is believed that having a single compartment allows for simplified use when filling the device as well as an easier to clean device between uses.

In another embodiment, the hollow body comprises more than one compartment wherein none of said more than one compartments are adjacent compartment contained within another compartment (for example two hemispherical compartments), not concentric compartments where one container is contained within another container. Where the hollow body defines more than one compartment, each compartment can have a separate composition ingress portal. Each compartment can have its own composition ingress portal as well as one or more composition egress portals of different size and shape to allow for controlled release of different types of fabric conditioners. In one embodiment of the present invention comprising more than one compartment, the first compartment is filled with a fabric softener, and the second compartment is filled with a perfume composition, such as a perfume oil or a perfume microcapsule.

c. At Least One Composition Egress Portal

The hollow body of the present invention defines at least one composition egress portal from the interior of said hollow body to the exterior of said hollow body. As defined herein, an “egress portal” is an orifice formed in the single layer of the hollow body, allowing for a composition to be dosed into the interior of the hollow body without leakage before introduction into the automatic drying cycle, but allows the composition to exit the hollow body during the drying cycle. In one embodiment, the hollow body defines a single egress portal. In another embodiment, the hollow body defines a plurality of egress portals, for example, from 4 to 32, or from 12 to 24. Said plurality of egress portals can be distributed throughout the entire hollow body or within a discreet section or sections of the hollow body. Suitable arrangements of said plurality of egress portals include, but are not limited to: uniformly dispersed, randomly dispersed, and dispersed in one or more rings around said hollow body. In yet another embodiment, the cap further comprises at least one egress portal.

In one embodiment, said at least one egress portal with a cross sectional area of less than about 1.2 mm², alternatively less than about 0.8 mm², alternatively less than about 0.6 mm², alternatively less than 0.2 mm², alternatively less than 0.05 mm², alternatively less than 0.03 mm² In addition to said at least one egress portion having a cross sectional area as defined previously, the hollow body can define additional egress portals having varying cross sectional sizes for example up from about 0.05 mm² inches to about 5 mm², alternatively from about 0.10 mm² inches to about 1 mm². Without intending to be bound by theory, it is believed that an egress portal having a cross sectional area which is too large would be susceptible to product leakage. It is believed that by providing one or more egress portals which are within the size range as mentioned herein, the surface tension of any fabric conditioner contained within the ball at 25° C. is sufficiently high to keep the fabric conditioner from leaking prior to the automatic tumble dry process where the heat, centrifugal force and tumbling is believed to cause the fabric conditioner to escape the hollow body.

In another embodiment, said at least one egress portal comprises an total cross section area of at least 1 mm², alternatively at least about 5 mm², alternatively at least about 10 mm², up to about 50 mm², alternatively up to about 25 mm², alternatively from about 20 mm².

In one embodiment, wherein said hollow body defines more than one egress portal, said more than one egress portals comprises a total cross sectional area of less than about 50 mm², alternatively from about 5 mm² to about 15 mm². As defined herein, the total cross sectional area means the aggregate of the cross sectional area of each of said at least one egress portals defined by said hollow body.

In another embodiment of the present invention, said hollow body defines said at least one egress portal comprising a tapered egress portal or cone shaped egress portal. A suitable orientation for the tapered egress portal one egress portal includes where the cross sectional area of the tapered egress portal at the exterior of the hollow body is larger than the cross sectional area at the interior of the hollow body. In an exemplary suitable embodiment, the cross sectional area of the tapered egress portal increases monotonically from the interior of the hollow body to the exterior of the hollow body.

It is generally undesirable for excessive amounts of the fabric conditioning composition to be applied to discreet portions of the fabrics. As such, the size, location, and number of egress portals can be selected based on the desired dispensing rate and distribution pattern. For example, where a faster dispensing rate is desired, the cross sectional area of said at least one egress portal can be increased or more egress portals can be provided.

It is believed that an egress portal as disclosed herein is sufficiently small such that when the fabric conditioner composition is loaded into the hollow body, no noticeable amount of composition leaks through the egress portal until after the composition dispensing container is subjected to the automatic drying process. During use with an automatic drying process composition dispensing container is placed into the drum of an automatic dryer where the rotations of the drum and/or heated air decrease the compositions viscosity to a point where the composition can flow out of said at least one egress portal.

Additionally, the composition dispensing container of the present invention is also suitable for use in the washing cycle. When used in the washing cycle, the single chamber compartment containing the fabric conditioning composition will accept wash and/or rinse water as the tub of the automatic washer fills with water. Any water which enters the single chamber compartment though said at least one egress portal will dilute the fabric conditioning composition, thereby decreasing the viscosity of the composition within the single chamber compartment. As the rinse cycle begins, the centrifugal force of the spinning washing tub will drive the composition out of said at least one egress portal onto the fabrics.

d. Composition Ingress Portal

The product dispensing container of the present invention comprises a composition ingress portal which allows passage of the composition into the hollow body of the composition dispensing container through a one way entry valve. The composition ingress portal is formed from the hollow body.

When loading the composition dispensing container, a composition is introduced into the hollow body via said composition ingress portal. Egress of the composition through said composition ingress portal is blocked by said one way entry valve. The composition ingress portal is in fluid communication with the one way entry valve, forming a fluid channel whereby any composition entering the composition ingress portal is transferred to the one way entry valve. In one embodiment, the cap defines a composition ingress portal wherein the one way entry valve is located radially inward from the composition ingress portal. In this embodiment, the composition ingress portal and the one way entry valve are flush. In one embodiment, the cap protrudes from the general spherical shape of the hollow body, in another embodiment the cap is flush or recessed into the hollow body.

e. One Way Entry Valve

The one way entry valve of the present invention comprises any type of valve which allows a composition to pass through the valve in one direction but not in the opposite direction. Suitable examples of one way entry valves including but not limited to: a duck-billed valve, a slit valve, a check valve, a ball check valve, a swing check valve, inflowing clapper valve, a stop-check valve, and a lift check valve. In one embodiment, the one way entry valve is a sufficiently narrow tube wherein the fabric conditioner composition can be forced through the tube into the inner volume of the hollow body but cannot pass back through the tube. The fabric conditioner composition in this embodiment can be stored in a pressurized container such that there is sufficient force to push the fabric conditioner composition through the tube into the hallow body.

The one way entry valve allows for introduction of the fabric conditioner composition into the hollow body via the composition ingress portal but obstructs or prohibits the release of the fabric conditioner composition from the hollow body through the same composition ingress portal. As such, the release of the fabric conditioner composition is achieved by the passage of the composition through said at least one composition egress portal.

In one embodiment, the one way entry valve when not being accessed remains flush to the cap at the location of the composition ingress portal such that the one way entry valve and the outer surface of the cap form a generally planar surface. In another embodiment, the one way entry valve extends into the interior of the hollow body.

In yet another embodiment, the one way entry valve comprises a rubber or elastic membrane which is biased to remain in a sealed position during rest but allows for access into the interior of the composition dispensing container by opening inwards into the composition dispensing container. In one embodiment, the one way entry valve comprises a silicone rubber membrane. Examples of suitable one way entry valves are disclosed in U.S. Pat. No. 5,989,469 to Dirr et al., U.S. Pat. No. 5,931,352 to Dirr et al., U.S. Pat. No. 5,897,033 to Hiroyuki Okawa et al., U.S. Pat. No. 4,728,006 to Drobish et al. Those of ordinary skill will understand that a valve or membrane used for a pressure activated dispensing type container, (i.e., a self-sealing dispensing valve on a shampoo bottle) can be used with the present invention in an inverted position to allow a pressurized feed to introduce the fabric conditioner into the hollow body.

f. Cap

The composition dispensing container further comprises a cap. In one embodiment, the cap and the hollow body form the single chamber compartment. In another embodiment, said cap forms said composition ingress portal.

In one embodiment, the cap is removable. Where a removable cap is used, the cap and hollow body are removably attached by any means suitable to create a seal between the cap and hollow body, for example a screw on cap. Further, where a removable cap is used, the cap comprises the composition ingress portal and one way entry valve. During use of the present invention, the cap need not be removed as the composition can be fed into the container via the composition ingress portal. This is believed to simplify the loading or charging process as the user would not need to use two hands to unscrew or remove the cap before loading the composition into the container. The removable cap allows for the additional benefit of allowing the user to access the interior of the hollow body, such as with the fingers or a tool or brush, if needed. Suitable removable caps include screw on caps and snug fit caps, snap fit caps, and a plug seal. Suitable caps form a seal between the cap and the hollow body. In another embodiment, the cap is molded or permanently/semi-permanently attached to the hollow body.

In one embodiment, the cap forming the composition ingress portal can be made of the same composition as the hollow body. In one embodiment, where the hollow body is clear and/or translucent, the cap is opaque.

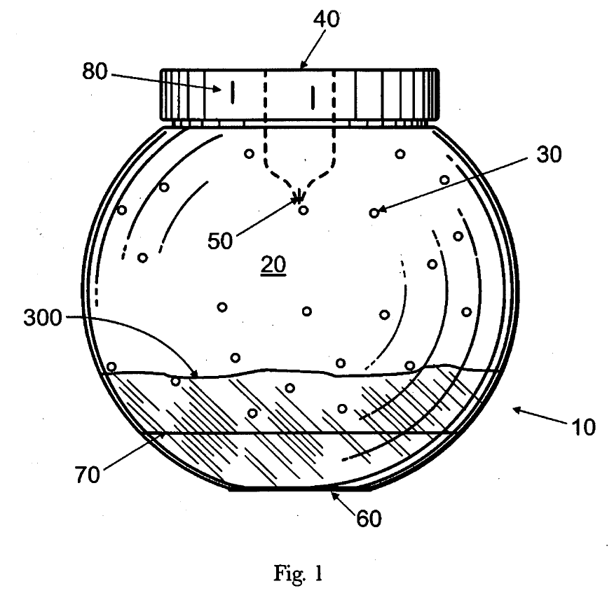

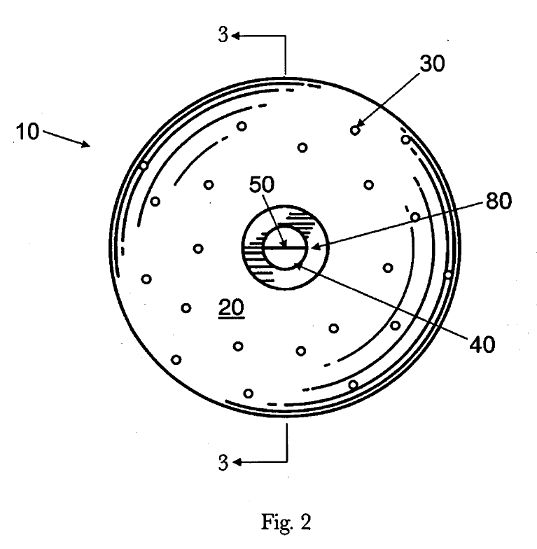

The relative positioning of the cap with respect to the hollow body is believed to impact how the article travels and moves about the drying tub of an automatic dryer. In one embodiment, the cap protrudes out from the general shape of the hollow body. See FIG. 1. It is believed that having a protruding cap can allow for more random movement of the article during the drying cycle. Conversely, it may be desirable for the cap not to protrude from the hollow body shape as this will minimize the likelihood of the article getting ensnared by an article of clothing. In this case, the cap is positioned to be either embedded within the shape of the hollow body or flush to the shape of the hollow body. See FIG. 2.

g. Fill Line

In one embodiment of the present invention, the hollow body comprises a fill line. In another embodiment, the hollow body comprises more than one fill line. By providing a fill line, the user can determine control the amount of desired benefit the user wants to impart on their laundered fabrics. In one embodiment, the hollow body is sufficiently translucent such by filling the hollow body with composition, such as a fabric conditioning composition, up to the level of a fill line, the user can decide the degree of benefit to impart. For example, a plurality of fill lines can be provided to demark volume levels, such as 1 fluid ounce, 2 fluid ounces, 3 fluid ounces, and 5 fluid ounces.

In another embodiment, where the composition dispensing container is used along with a metered composition storage reservoir or metered releasably attachable adapter (as described in detail below) no fill line or indicia to show the amount of composition loaded into the container is used. In this embodiment, no indicia is required as the metered transfer of composition can be manipulated to allow users to control how much benefit they want to impart on their fabrics, for example, pump once for soft, pump twice for extra soft. Instructions for this type of use can be included with the present invention.

h. Egress Portal Seal

In one embodiment of the present invention, the composition dispensing container further comprises an egress portal seal positioned in the vicinity of the section of the hollow body defining said at least one egress portal. This egress portal seal provides for controlled dispensing of the composition during use of the composition dispensing container. In one embodiment, where the hollow body defines a plurality of egress portals, the composition dispensing container also comprises an equal number of egress portal seals, each of which are operably positioned to seal or partially block passage of any compositions through said egress portals. By controlling the ability of composition to pass through said at least one egress portal, the present invention allows for controlled dispensing of the fabric conditioning composition.

Non-limiting examples of suitable egress portal seals include a removably attached plug; a slidable cover; a slidable ring; and combinations thereof.

Suitable removably attached plugs include any flexible rubber or plastic material comprising an affixed segment and a plug segment. In one embodiment, wherein said hollow body defines a plurality of egress portals and a plurality of removably attached plugs, said removably attached plugs can be separately engaged to be in a sealing position such that the less than all of said plurality of egress portals need be sealed therefore providing a partially blocked passage of said plurality of egress portals.

Suitable slidable covers include those disclosed in U.S. Pat. No. 5,697,533. Those of skill in the art will recognize that similar configurations can be applied to the present invention, wherein said slidable cover can be positioned to seal or expose said at least one egress portal as needed. In one embodiment, said slidable cover comprises a turning disc member enveloping a segment of said hollow ball, such as a ring or band or a cup or partial dome shape.

In another embodiment, said egress portal seal is a slidable ring oriented around a waist of the hollow body. This slidable ring defines at least one ring egress portal wherein when said slidable ring is positioned in an open orientation, said at least one ring egress portal exposes said at least one egress portal defined by the hollow body. In a closed orientation, said at least one ring egress portal is not aligned with said at least one egress portal defined by the hollow body, thereby limiting the ability of the composition to escape the hollow body. Further, it is conceived that the egress portal seal can expose at least one egress portal while blocking at least one egress portal, producing a partially open or partially closed orientation.

i. Base

In one embodiment of the present invention, the composition dispensing container further comprises a base for placing said composition dispending container on a flat surface. The location of the base can be selected to allow the user to visibly see the amount of composition with respect to the fill lines, if supplied. In one embodiment, the base is located opposite the portion of the composition dispensing container which includes the composition ingress portal. In another embodiment, the base is located around the portion of the hollow body surrounding the composition ingress portal.

j. Noise Reducing Material

In one embodiment of the present invention, the composition dispensing container further comprises a noise reducing material enveloping at least a portion of the outer surface of the hollow body. This noise reducing material can envelop a discrete portion of the outer surface of the hollow body or can envelop the entire outer surface of the hollow body. Non-limiting examples of discrete portions of said hollow body include: a band around a portion of the outer surface of the hollow body, a band around a waist of the outer surface of the hollow body, at least one patch comprising a circular or dome shaped patch, a triangular patch, or any other shape which covers a portion of the outer surface of the hollow ball without unduly obscuring said plurality of egress portals.

In one embodiment, the noise reducing material is from about 10%, alternatively from about 25%, alternatively from about 50%, alternatively from about 75%, alternatively about 90% to about 99%, alternatively to about 90%, alternatively to about 75%, alternatively to about 50%, alternatively to about 25% of said outer surface of said hollow ball. It is believed that the noise reducing material decreases the amount of noise created by the movement of the composition dispensing container when used in an automatic dryer and/or washer by cushioning the impact created when the composition dispensing container strikes the dryer and/or washer interior walls. Further, it is believed that this noise reducing material can extends the life of the composition dispensing container because the noise reducing material acts as a shock absorbing layer protecting the more fragile elements of the container.

Suitable materials for use as noise reducing materials include foam, rubber, semi-soft rubber materials, thermoplastic foam or rubber, enclosed gels, and mixtures thereof. In one embodiment, the noise reducing material is made of polyurethane, polypropelene, and mixtures thereof. Suitable materials are known in the art and should be selected to retain their structural integrity at elevated temperatures common to automatic dryer machines, for example above 100° F. to 200° F. Suitable materials are disclosed as grip or coating materials in U.S. Pat. Nos. 5,988,909, 4,696,842, and 6,101,636. Non-limiting examples of commercially available materials include BAYFIT® Tec Foam by Bayer Material Science of Leverkusen, Germany,

k. Container Weight

The composition dispensing container comprises an empty container weight from about 5 grams, alternatively from about 50 grams, alternatively from about 100 grams, to about 250 grams, alternatively to about 150 grams. The composition dispensing container will weigh more when the composition is filled into the hollow body. It is believed that having an empty container weight as defined allows the container to move around the interior of an automatic dryer machine and/or automatic washing machine, in a randomized pattern. Where the container is not sufficiently heavy, it is believed that the container can become entrapped by the fabrics being treated and lead to insufficient dispersal of the composition.

### 2. Compositions

The composition dispensing container of the present invention is suitable for use with compositions including but not limited to fabric conditioning compositions. Suitable fabric conditioning compositions include but are not limited to conventional fabric softeners, perfumes, mal-odor agents, antibacterial agents, shape retention polymers, antiwrinkle agents, antistatic agents, brighteners, and those known in the art.

In one embodiment, the composition as it enters the composition dispensing container is in the form of a liquid, a gel, a foam, a foaming gel, or a fluidized solid or semi-solid. Depending upon the composition storage container, this composition can be stored in different forms prior to being introduced into the composition dispensing container.

Compositions suitable for use with the present invention are those which do not leak out of the composition dispensing container through said at least one egress portal until the apparatus is subjected to the automatic drying process or the wash and/or rinse cycle of an automatic washer. In one embodiment, the composition comprises shear thinning characteristics. Non-limiting examples of compositions having suitable shear thinning characteristics are disclosed in: U.S. Pat. No. 5,407,588. In one embodiment, the composition comprises a viscosity of from about 10×10⁻⁴ Pa·s to about 200×10⁻⁴ Pa·s, alternatively from about 50×10⁻⁴ Pa·s to about 120×10⁻⁴ Pa·s at about 25° C. and atmospheric pressure of about 101 kPa.

In another embodiment, the composition is a newtonian fluid. In one embodiment, the composition has a viscosity of from about 1 cp to about 500 cp, alternatively from about 5 cp to about 400 cp, alternatively from about 10 cp to about 200 cp, alternatively from about 25 cp to about 50 cp.

### 3. Composition Storage Container

Another embodiment of the present invention provides for a composition storage container comprising a reservoir for storing said composition and engagement portion adapted to be releasably attached with said cap and composition ingress portal of said composition dispensing container. Prior to use, the composition storage container and the composition dispensing container are releasably attached such that a fluid transportation channel is created allow for passage of the composition from the reservoir into the hollow body. In one embodiment, the fluid transportation channel is substantially non-leaking, meaning that during the process of loading the composition into the composition dispensing container, no noticeable amount of composition leaks or spills. As used herein, releasably attached includes any form of engagement which allows the user to engage then disengage the composition dispensing container from the composition storage container, including threads structures; tongue and groove structures; magnets; push-pull snap closures, snug fitting closures and snap-fit closures.

In one embodiment, the engagement portion of the composition storage container comprises a container neck, such as a threaded neck which can be sealed with a screw on cap. The neck can be smooth or can be threaded, such that when engaged by the composition ingress portal of the composition dispensing container, a fluid transportation channel is formed allowing for passage of composition from the reservoir to the one way entry valve. In this embodiment, the one way entry valve can be opened by any external pressure such as a squeeze of the body of the composition storage container, or by aligning the two engaged containers such that the composition dispensing container is below the composition storage container allowing gravity to draw fluid down into and through the one way entry valve.

In another embodiment, the engagement portion of the composition storage container further comprises a protruding unit (for example, a feed or spigot). When the composition storage container is releasably engaged with the composition dispensing container, the protruding unit can be positioned to bias the one way entry valve open, thereby allowing for passage of composition into the hollow body.

Where the composition is transferred from the composition storage container into the composition dispensing container via an applied pressure, the composition storage container can be a manually squeezable container or a pump container. An applied pressure upon the composition stored within the container can be generated by pumping air into the reservoir or by squeezing the container body. The composition stored in the reservoir is then driven into and through the fluid transportation channel and into the hollow body of the composition dispensing container. Non-limiting examples of suitable bottle and pump configurations, such as those used for dispensing hand soaps or other fluids or vapors, are disclosed in: U.S. Pat. Nos. 3,146,920; 3,628,700; 3,760,986; 3,986,644; 4,565,402; 4,899,913; 5,497,944.

In another embodiment, the composition storage container stores the composition in a pressurized state. As such, no additional pressure is needed to transport the composition from the reservoir into the hollow body, rather, the pressurized composition, stored within the reservoir will travel into the hollow body upon actuation of a pump or trigger. The pressurized composition is then released from the storage container through said fluid transportation channel. Where the one way entry valve is not biased open by a protruding member, the force generated by the released pressurized composition can be sufficient to open the one way entry valve, allowing for access into the hollow body. One suitable non-limiting example of such a composition storage container includes an aerosol container, such as those used to store hair styling products. During operation, the pressurized composition is transferred into the hollow body by the triggering of a release from the aerosol container. The composition is thereby dispensed into the composition dispensing container as droplets of liquid, a gel, a foam, or a foaming gel.

### 4. Releasably Attachable Adapter

In another embodiment, the fluid transportation channel between the composition storage container and composition dispensing container is formed via a releasably attached adapter. The releasably attachable adapter comprises a first fitment engaging said composition storage container, said engagement comprising a releasable attachment to said neck of said composition storage container; a second fitment engaging said composition dispensing container cap about said composition ingress portal, said engagement comprising a releasable attachment. The releasably attachable adapter forms a fluid transportation channel between said composition storage container and said composition dispensing container. Both first and second fitments form substantially non-leaking engagements and allow the composition to be transferred from the reservoir through adapter into the hollow body. This element allows the composition dispensing portal to be used with conventional liquid fabric softener bottles. Further adapters having varying first fitments can be provided allowing users to use the same composition dispensing container with different composition storage reservoirs by substituting different adapters.

In yet another embodiment, the releasably attachable adapter further comprises the pump. Suitable adapters for use herein include those used in conventional hand soap dispensers or spray dispensers, wherein the adapter and pump can be removed from the bottle to allow for refilling of the bottle. As used in the present invention, the dispensing portion of the conventional adapter would be directed into the composition ingress portal through the one way entry valve, thereby allowing composition to be deposited into the hollow body upon pumping. Non-limiting examples of suitable pump adapters include those disclosed in: U.S. Pat. Nos. 4,944,429; 4,620,646; and 4,809,878.

### 5. Metered Transfer of Composition

In one embodiment, the transfer of composition from said composition storage container is metered such that only a preset volume or amount of composition is transferred upon use. For example, where the composition storage container comprises a pump, each actuation of said pump can deliver a present volume of composition into said hollow body, such as one actuation delivers 1 oz of composition. This metered transfer can also be achieved with the releasably attachable adapter. In one embodiment, the apparatus is accompanied with indicia or instructions informing the user how to control the metered transfer such that they can achieve their desired amount of benefit based on the number of times they actuate the pump or press a trigger button. It is believed that this process allows users to load or charge the composition dispensing container with a simple process without having to monitor a fill line or worry that they will over charge the container, leading to spills or leakage.

### 6. Methods of Use

A process aspect of the present invention provides for a process for treating a fabric in a dryer cycle comprising: charging a composition dispensing container according to the present invention with a fabric conditioning composition; introducing said charged composition dispensing container into the drum of an automatic dryer; providing a fabric into said automatic dryer either before or after step (b); and running said automatic dryer containing said charged composition dispensing container and said fabric. It is believed that the elevated temperature of the automatic drying process as well as the centrifugal force created by the rotating automatic dryer drum create sufficient action to allow the fabric conditioning composition to escape the composition dispensing container through said at least one egress portal, thereby coming into contact with the fabrics.

Another process aspect of the present invention provides for a process for treating a fabric in a wash and/or rinse cycle comprising: charging a composition dispensing container according to the present invention with a fabric conditioning composition; dispensing said charged composition dispensing container into an washing basin; providing a fabric into said washing basin either before or after step (b); and washing and/or rinsing said fabric within said washing basin such that the charged fabric dispensing container releases a fabric conditioning composition from said at least one egress portal.

In yet another process aspect of the present invention, the process for charging the composition dispensing container comprises: releasably attaching a composition dispensing container to a composition storage container to form a fluid transportation channel; transporting a fabric conditioning composition from said composition storage container through said fluid transportation channel into said hollow body of said composition dispensing container; and releasing said composition dispensing container from said composition storage container. In an alternative embodiment, the composition dispensing container is releasably attached to an adapter, which is releasably attached to the composition storage container. Further, the step of transporting said fabric conditioning composition can be achieved by any of the ways disclosed herein, by gravity, applied pressure within the reservoir, or a pump.

### 7. Detailed Description of the Drawings

FIG. 1 provides a side view of one embodiment of the present invention of a composition dispensing container 10, comprising a hollow body 20 defining at least one egress portal 30. Said article has a cap 80 forming a composition ingress portal 40 and a one way entry valve 50 which is connected to said cap about said composition ingress portal. FIG. 1 also shows the optional elements of a base 60 allowing the container to rest on a flat surface as well as at least one fill line 70. Further shown in FIG. 1 is a volume of liquid fabric enhancing composition 300 stored within said hollow body.

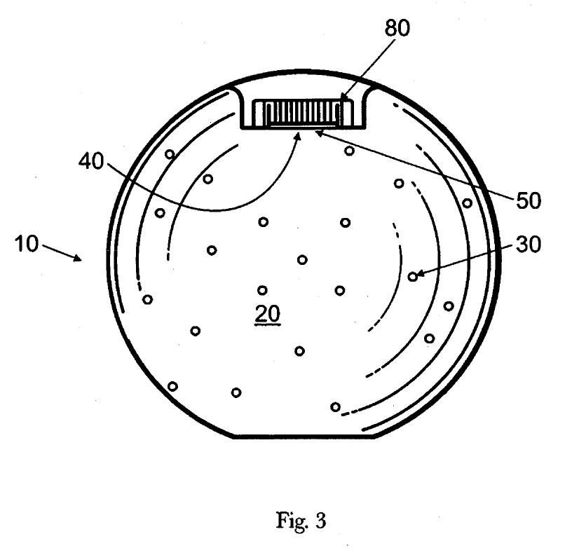

FIGS. 2 and 3 provide a top view and a cross-sectional view along view line 3-3, of one embodiment of the present invention, respectively. FIG. 3 provides a cross sectional view of the embodiment of FIG. 2. In this embodiment, the cap 80 and composition entry portal 40 are positioned within the general ball shape of the hollow body 20. Further, a cap which rests flush to the outer shape of the hollow body is also envisioned in the present invention.

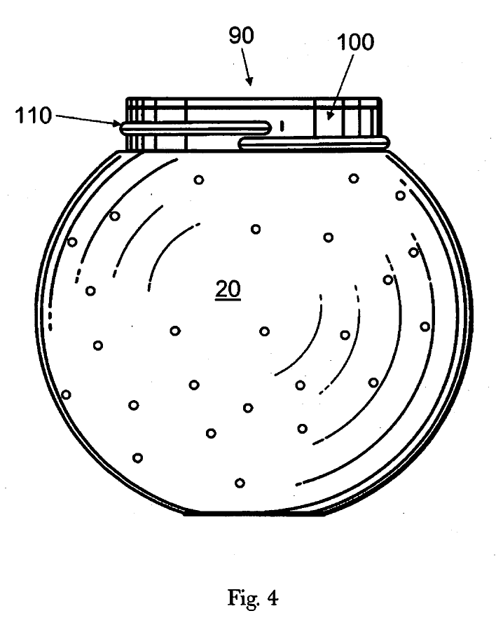

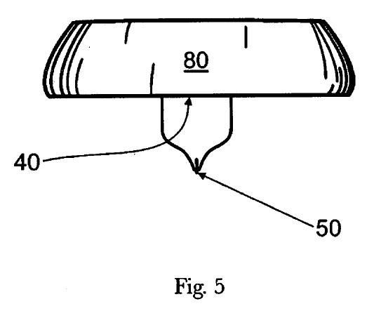

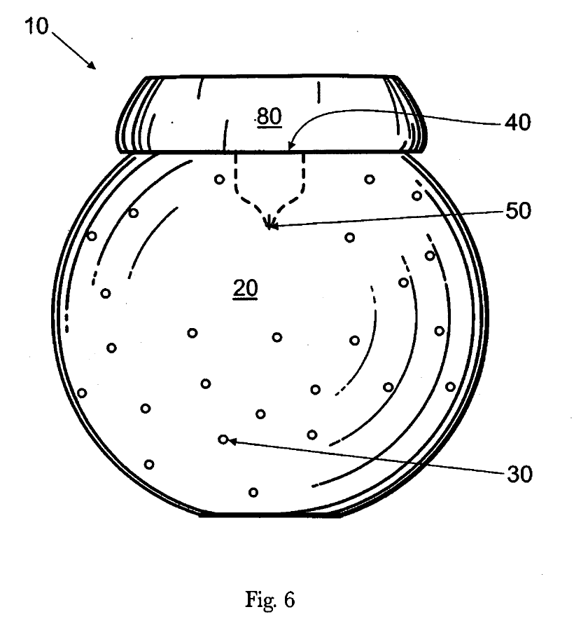

FIGS. 4 and 5 provide side views of the separate components of the article wherein FIG. 4 is the hollow body comprising a neck 100 defining a cap receiver opening 90 comprising screw thread fitment 110 and FIG. 5 is the screw on cap 80 with duck bill valve 50. FIG. 6 shows the screw on cap 80 releasable attached to the hollow body 20.

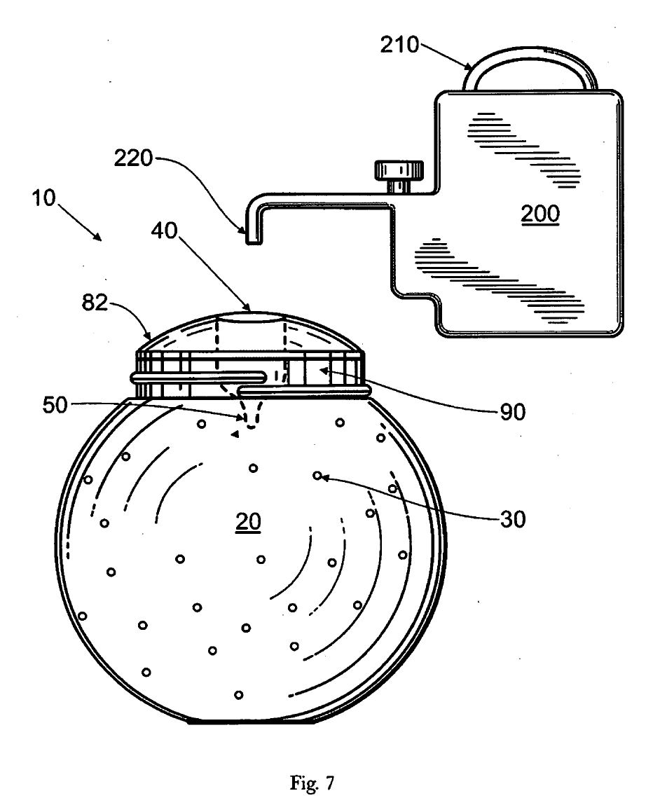

FIG. 7 shows another embodiment, comprising a composition dispensing container 10 comprising a plug seal cap 82 comprising a duck billed valve 50, wherein said plug seal cap seals the cap receiving opening 90. FIG. 7 further shows a composition storage container 200 having a handle 210 and a spigot 220 which can access the duck billed valve of the composition dispensing container to transfer a composition into the hollow body 20. In operation, the spigot of the composition storage container accesses the composition ingress portal 40 and accesses the interior of the hollow body via the duck billed valve. Composition is then delivered into the hollow body 20 such that product cannot exit back out of the composition dispensing container because of the duck billed valve being a one way entry valve.

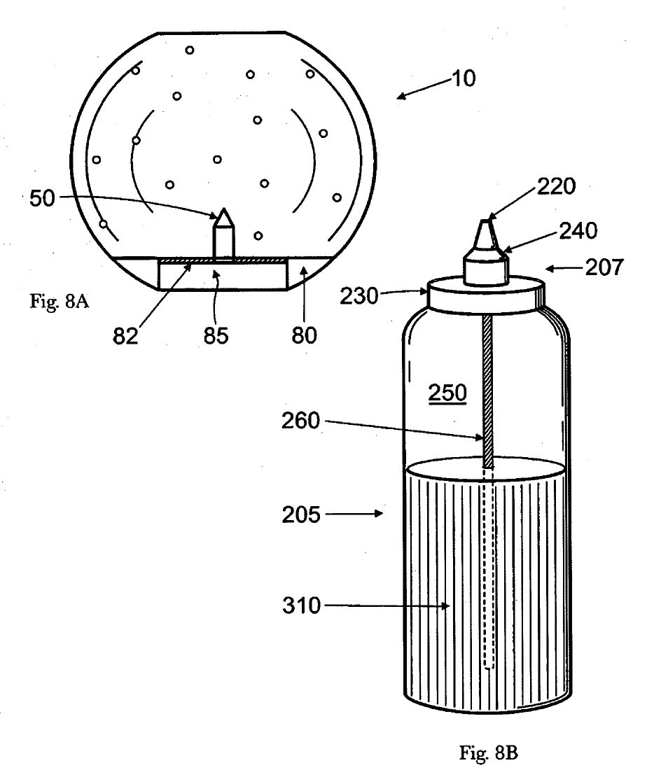

FIG. 8 shows a composition dispensing container 10 and a composition storage container 205 comprising a reservoir 250 and a releasably attachable adapter 207, said reservoir containing a composition 310, wherein the composition dispensing container comprises a cap 80 comprising a cap plate 82 and defines a chamber 85. The releasably attachable adapter 207 is shown already attached to said reservoir 205, said releasably attachable adapter comprising a neck 230 comprising a feed 220 and an actuator 240 which when depressed will allow a volume of composition from within said composition storage container to be driven into a reservoir stem 260 to said feed. When preparing to charge the composition dispensing container, the composition dispensing container is placed upon a composition storage container 205 such that said chamber fits about said composition storage container cap 230 and feed 220 penetrates one way entry valve 50. When charging, a pressure is placed upon the composition dispensing container such that the cap plate 82 comes into contact with the actuator 240 of said composition storage container. A volume of composition is thereby emitted out of said feed 220 through said one way entry valve 50. The composition dispensing container shown in FIG. 8 further shows one embodiment wherein the cap is suitable to act as the base.

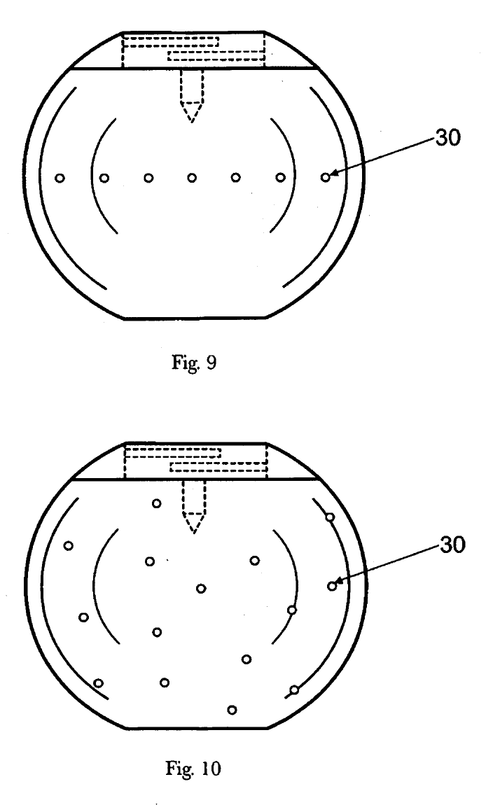

FIG. 9 shows one embodiment of the present invention wherein said at least one egress portal 30 is positioned in a discrete section of said hollow body 20. In this embodiment, said at least one egress portal is positioned in a line about the waist of the hollow body.

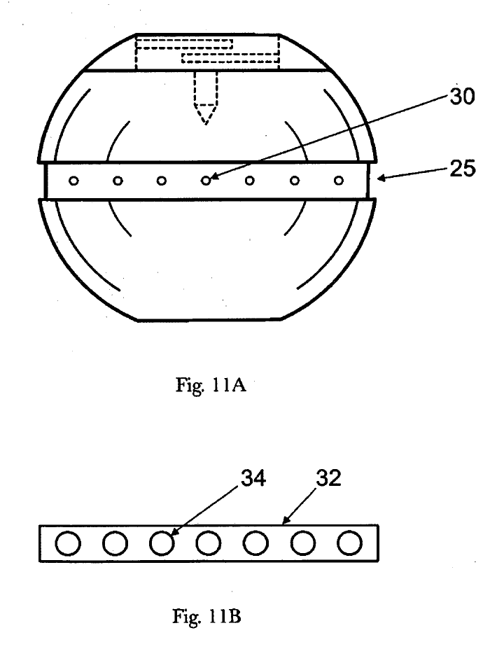

FIG. 10 shows another embodiment wherein said at least one egress portal 30 are randomly positioned throughout said hollow body 20.

FIG. 11 shows an exploded view of yet another embodiment comprising an egress portal seal in the form of an ancillary slidable ring 32 forming at least one ring opening 34, wherein said slidable ring fits about said hollow body comprising a waist 25. Those of skill in the art will recognize that the waist can be positioned at sections of the hollow body other than at the widest part. In operation, said ancillary slidable ring can be positioned such that said at least one egress portal is overlayed or partially overlayed by a portion of said slidable ring other than said at lest one ring opening. The passage of composition from the interior of said hollow body through said at least one egress portal is thus controlled by the alignment of said slidable ring.

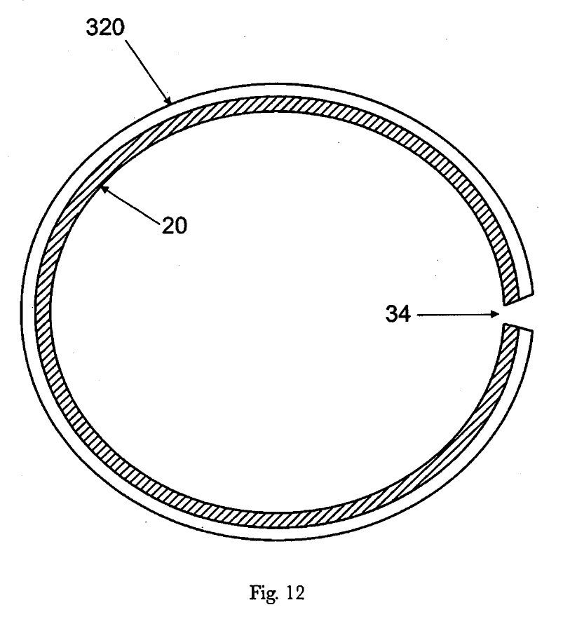

FIG. 12 shows another embodiment, wherein said hollow body 20 forms at least one egress portal comprising a tapered egress portal 34. The cross sectional area of the tapered egress portal facing the interior of the hollow body is smaller than the cross sectional area of the tapered egress portal facing the exterior of the hollow body. In another embodiment, the tapered egress portal is oriented such that the cross sectional area of the tapered egress portal facing the interior of the hollow body is larger than the cross sectional area of the tapered egress portal facing the exterior of the hollow body. FIG. 12 further shows an embodiment where at least one egress portal is not obstructed by said noise reducing material 320.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the DETAILED DESCRIPTION OF THE INVENTION are, in the relevant part, incorporated herein by reference; the citation of any document is not to be construed as an admission that it is prior art with respect to the present invention. To the extent that any meaning or definition of a term or in this written document conflicts with any meaning or definition in a document incorporated by reference, the meaning or definition assigned to the term in this written document shall govern.

Except as otherwise noted, the devices “a,” “an,” and “the” mean “one or more.”

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A composition dispensing container comprising:
a. a hollow body forming an inner volume, said hollow body comprising:
i. a single layer interface between said inner volume and the environment exterior to said hollow body;
ii. a composition ingress portal allowing a composition to be introduced into said inner volume from the environment exterior to said hollow body; and
iii. at least one composition egress portal allowing a composition to exit said inner volume to the environment exterior to said hollow body; and
b. a one-way entry valve operably connected to said composition ingress portal.

2. The composition dispensing container of claim 1, wherein said hollow body comprises a substantially spherical shape.

3. The composition dispensing container of claim 1, further comprising at least one egress portal seal operably positioned on or about said at least one egress portal.

4. The composition dispensing container of claim 3, wherein said at least one egress portal seal comprises a removably attached plug; a slidable cover; and a slidable ring, and combinations thereof.

5. The composition dispensing container of claim 1, wherein said at least one egress portal comprises an egress portal cross sectional area of less than about 1 mm².

6. The composition dispensing container of claim 5, wherein said total egress portal cross sectional area of from about 1 mm² inches up to about 50 mm².

7. The composition dispensing container of claim 1, wherein said at least one egress portal comprises a tapered egress portal.

8. The composition dispensing container of claim 1, wherein said hollow body comprises a base.

9. The composition dispensing container of claim 1, wherein said single chamber compartment further comprises a cap, wherein said cap forms said composition ingress portal.

10. The composition dispensing container of claim 1, wherein said one-way entry valve is selected from the group comprising a duck-billed valve, a slit valve, a check valve, a ball check valve, a swing check valve, inflowing clapper valve, a stop-check valve, and a lift check valve.

11. The composition dispensing container of claim 10, wherein said one way entry valve comprises a silicone rubber membrane.

12. The composition dispensing container of claim 1, further comprising a fabric conditioning composition contained within said hollow body, wherein said fabric conditioning composition comprises: a liquid, a foam, a gel, and mixtures thereof at 78° F.

13. The composition dispensing container of claim 1, further comprising a noise reducing material enveloping at least a portion of the outer surface of said hollow body.

14. An kit comprising:
a. a composition storage container comprising:
i. a reservoir; and
b. a composition dispensing container comprising:
i. a hollow body forming an inner volume, said hollow body comprising:
1. a single layer interface between said inner volume and the environment exterior to said hollow body;
2. a composition ingress portal allowing a composition to be introduced into said inner volume from the environment exterior to said hollow body; and
3. at least one composition egress portal allowing a composition to exit said inner volume to the environment exterior to said hollow body; and
ii. a one-way entry valve operably connected to said composition ingress portal,
wherein said composition storage container and said composition dispensing container are releasably attached, forming a fluid transportation channel.

15. The kit of claim 14, wherein said fluid transportation channel is substantially non-leaking.

16. The kit of claim 15, wherein said releasable attachment is formed by threaded structures; tongue and groove structures; magnets; push-pull snap closures, snug fitting closures and snap-fit closures.

17. The kit of claim 14, wherein said composition storage container is selected from the group consisting of a manually squeezable container, a pump container, and an aerosol container.

18. The kit of claim 14, wherein said fluid transportation channel is formed by a releasably attachable adapter comprising a first fitment engaging said composition storage container and a second fitment engaging said composition dispensing container.

19. The kit of claim 18, wherein said releasably attachable adapter further comprises a hand pump, wherein when said hand pump is actuated, a volume of composition is delivered from said composition storage container into said composition dispensing container.

20. A process for treating a fabric in a dryer cycle comprising:
a. charging a composition dispensing container with a fabric conditioning composition, said composition dispensing container comprising;
i. a hollow body forming an inner volume, said hollow body comprising:
1. a single layer interface between said inner volume and the environment exterior to said hollow body;
2. a composition ingress portal allowing a composition to be introduced into said inner volume from the environment exterior to said hollow body; and
3. at least one composition egress portal allowing a composition to exit said inner volume to the environment exterior to said hollow body; and
ii. a one-way entry valve operably connected to said composition ingress portal;
b. introducing said charged composition dispensing container into an automatic dryer;
c. providing a fabric into said automatic dryer either before or after step (b); and
d. running said automatic dryer containing said charged composition dispensing container and said fabric.
